(19) United States
(12) Patent Application Publication
(10) Pub. No.: US 2004/0228289 A1
(43) Pub. Date: Nov. 18, 2004

(54) Apparatus for determining shaping rate and method of doing the same

(75) Inventor: Masanori Sano, Tokyo (JP)

Correspondence Address: Norman P. Soloway, HAYES SOLOWAY P.C., 130 W. Cushing Street, Tucson, AZ, 85701, US

(73) Assignee: NEC Corporation

(21) Appl. No.: 10/845,938

(22) Filed: May 13, 2004

(30) Foreign Application Priority Data
May 13, 2003 (JP) 2003-134768

(51) Int. Cl. H04L 12/26

(52) U.S. Cl. 370/253

(57) ABSTRACT

An apparatus for determining a shaping rate, to make communication with a communication terminal through a best-effort type network, includes a Ping transmitter transmitting at least one Ping used for measuring a band, and Ping data indicative of the Ping, a first controller receiving the Ping from the Ping transmitter and transmitting the Ping in accordance with a priority thereof, a judgment unit receiving the Ping data from the Ping transmitter, and a second controller determining a shaping rate and shaping the Ping received from the first controller. The judgment unit makes band data indicative of an actually usable band, based on a response received from the communication terminal and the Ping data received from the Ping transmitter, and transmits the band data to the second controller, and the second controller varies a shaping rate in accordance with the band data received from the judgment unit.

### BACKGROUND OF THE INVENTION

1. Field of the Invention

The invention relates to an apparatus for determining a shaping rate, a system for doing the same, a method of doing the same, and a program for causing a computer to carry out the method.

2. Description of the Related Art

In conventional QoS (quality of service) technology, priority control and band control are carried out by network devices to thereby earlier transmit packets having a higher priority and narrow a band of an output interface, ensuring enhancement in communication quality in Internet and Intranet.

However, in a best-effort type network in which a band is not guaranteed, if a band of an actually using channel becomes smaller than a shaping rate, packets might by abandoned in the network regardless of a priority of the packets.

For instance, Japanese Patent Application Publication No. 2001-168871(A) has suggested a data transmission system in which when a lower-layer protocol has data indicative of a rate at which data can be transmitted from a network, an upper-layer protocol transmits packets at the rate indicated in the data.

Japanese Patent Application Publication No. 2002-217960(A) has suggested an IP-packet router which avoids a problem of concentration of packets to a particular processor to ensure that IP-packets are smoothly routed.

Japanese Patent Application Publication No. 2002-247092(A) has suggested a system for determining a band in a communication terminal acting as a node in a connectionless network. The system automatically sets a band to match to bands of all of the communication terminals arranged in a common network.

Japanese Patent Application Publication No. 10-145383(A) has suggested a shaping circuit which controls a period of time necessary for transmission of a next cell, in accordance with a reference shaping time as a reference period of time, and controls cell transmission in accordance with the period of time. The reference shaping time is determined in the range of 0% to 100%.

Japanese Patent Application Publication No. 11-317743(A) has suggested a scheduler which schedules a stream queue supplying cells having QoS conditions different from one another, and shapes a transmission rate such that congestion in a bottleneck in an ATM switch avoids.

Japanese Patent No. 2910746(B2) (Japanese Patent Application Publication No. 11-112511(A)) has suggested a method of traffic-shaping, including controlling a rate of an ATM cell transmitted from an ATM network device, applying a frame period to the ATM cell, and monitoring a transmission rate of the ATM cell.

Japanese Patent Application Publication No. 2000-49787(A) has suggested a band division system in which when a band is assigned to a plurality of connections, bands actually transmitted from a terminal device are divided to each of the connections in accordance with a priority of each of the connections.

Japanese Patent Application Publication No. 2000-101608(A) has suggested a shaping method for converting an input data flow of a rate of an input data packet into an output data flow of a rate of an output data packet.

Japanese Patent Application Publication No. 2000-115191(A) has suggested a shaping device including a shaper which buffers received data cell for each of kinds of data cell connection, and transmits the buffered data cell in accordance with a transmission rate defined for each of data cell connection, and a data transmitter which detects a sub-congestion condition just short of a congestion condition in which next data cell has to be abandoned in accordance with a number of data cell having been buffered for each of kinds of data cell connection, and a non-congestion condition, and transmits results of the detection to a device for transmitting data cell.

Japanese Patent Application Publication No. 2000-253056(A) has suggested a transmission-band controller in a data transmission device which makes communication with network, including a data buffer temporarily storing transmission data, first means for adding certain protocol data to the transmission data and transmitting the transmission data to the network, second means for transferring data at a predetermined interval for every certain volume of data between the data buffer and the first means, and varying the volume of data and the interval, and third means for calculating an interval at which the second means transmits data, based on both data indicative of a volume of data to be transmitted in a certain period of time and the certain volume of data, and indicating the calculated interval to the second means.

Japanese Patent Application Publication No. 2001-77819(A) has suggested a method of solving an address used when data is transmitted between first and second networks, including the steps of assigning a priority to data to be transmitted to the second network from the first network, monitoring wires in the second network, determining a transmission route and a transmission rate for transmitting data through the second network, varying a transmission rate of data having a low priority among data transmitted through the wires, when a rate at which the wires in the determined transmission route is over a threshold by transmitting the data, and re-arranging the wires in accordance with the varied transmission rate.

Japanese Patent Application Publication No. 2001-268118(A) has suggested a system for transmitting packets, including a node system through which a data packet passes, the data packet having a header including data indicative of a band necessary for communication through the use of the data packet, the node system including first means for receiving a data packet, second means for reading a header of the received data packet, and third means for judging whether a band necessary for making communication through the use of the data packet can be ensured based on the read-out header.

However, the systems and the router suggested in the above-mentioned Publications are accompanied with a problem of poor communication quality, because a usable band varies in accordance with a place, a time and/or a provider in a best-effort type network in which a band is not guaranteed.

### SUMMARY OF THE INVENTION

In view of the above-mentioned problem in the conventional systems, it is an object of the present invention to provide an apparatus for determining a shaping rate which apparatus is capable of automatically determining a band of an output interface of a communication terminal in accordance with a band in a best-effort type network such as Internet in which a band is not guaranteed.

It is also an object of the present invention to provide a system for doing the same.

It is further an object of the present invention to provide a method of doing the same.

It is further an object of the present invention to provide a program for causing a computer to carry out the method.

Hereinbelow is described the above-mentioned apparatus, system, method and program in accordance with the present invention through the use of reference numerals used in later described embodiments. The reference numerals are indicated only for the purpose of clearly showing correspondence between claims and the embodiments. It should be noted that the reference numerals are not allowed to use in the interpretation of claims of the present application.

In one aspect of the present invention, there is provided an apparatus for determining a shaping rate, to make communication with a communication terminal through a best-effort type network, including a Ping transmitter (201) transmitting at least one Ping packet used for measuring a band, and Ping data indicative of the Ping packet, a first controller (202) receiving the Ping packet from the Ping transmitter (201) and transmitting the Ping packet in accordance with a priority thereof, a judgment unit (206) receiving the Ping data from the Ping transmitter (201), and a second controller (203) determining a shaping rate and shaping the Ping packet received from the first controller (202), wherein the judgment unit (206) makes band data indicative of an actually usable band, based on a response received from the communication terminal (103, 303) and the Ping data received from the Ping transmitter (201), and transmits the band data to the second controller (203), and the second controller (203) varies a shaping rate in accordance with the band data received from the judgment unit (206).

The apparatus may further include a packet transmitter (204) through which the Ping packet is transmitted to the communication terminal from the second controller (203).

The apparatus may further include a packet receiver (205) which receives the response from the communication terminal and transmits the received response to the judgment unit (206).

It is preferable that the Ping transmitter (201) determines a number of Ping packets to be transmitted therefrom, and a packet size.

It is preferable that the Ping transmitter (201) transmits a control packet in place of the Ping packet.

It is preferable that the Ping packet measures a band of a communication terminal (40) disposed in a provider (403).

It is preferable that the first controller (202) assigns a minimum-guaranteed band to each of classes.

It is preferable that the first controller (202) inserts the Ping packet received from the Ping transmitter (201) and other packets into separate classes.

It is preferable that the first controller (202) assigns a minimum-guaranteed band to a class through which the Ping packet passes which band is lower than a minimum-guaranteed band to be assigned to a class through which the packets passes.

It is preferable that the second controller (203) determines a maximum shaping rate among shaping rates at which the Ping packet is transmitted from the second controller (203).

It is preferable that the Ping transmitter (201) determines an interval at which the actually usable band is measured.

In another aspect of the present invention, there is provided an apparatus for determining a shaping rate, to make communication with a communication terminal through a best-effort type network, including a packet transmitter (701) transmitting at least one control packet used for measuring a band, a first controller (702) receiving the control packet from the packet transmitter (701) and transmitting the control packet in accordance with a priority thereof, and a second controller (703) determining a shaping rate and shaping the control packet received from the first controller (702), wherein the second controller (703) receives band data indicative of an actually usable band, from the communication terminal (503), and varies a shaping rate in accordance with the band data.

It is preferable that the packet transmitter (701) determines a number of control packets to be transmitted therefrom, and a packet size.

It is preferable that the second controller (703) determines a maximum shaping rate among shaping rates at which the control packet is transmitted from the second controller (703).

It is preferable that the packet transmitter (701) determines an interval at which the actually usable band is measured.

In another aspect of the present invention, there is provided a method of determining a shaping rate at which communication is made with a communication terminal through a best-effort type network, including transmitting at least one Ping used for measuring a band, and Ping data indicative of the Ping, shaping the Ping, transmitting the shaped Ping to the communication terminal, receiving a response from the communication terminal, making band data indicative of an actually usable band, based on the response and the Ping data, and varying the shaping rate in accordance with the band data.

The method may further include determining an interval at which the band is to be measured, and varying the shaping rate at the interval.

There is further provided a method of determining a shaping rate at which communication is made with a communication terminal through a best-effort type network, including transmitting at least one control packet used for measuring a band, shaping the control packet, transmitting the shaped control packet to the communication terminal, receiving band data indicative of an actually usable band, from the communication terminal, making band data indicative of an actually usable band, based on the band data, and varying the shaping rate in accordance with the band data.

The method may further include determining an interval at which the band is to be measured, and varying the shaping rate at the interval.

In still another aspect of the present invention, there is provided a program for causing a computer to carry out a method of determining a shaping rate at which communication is made with a communication terminal through a best-effort type network, steps executed by the computer in accordance with the program including transmitting at least one Ping used for measuring a band, and Ping data indicative of the Ping, shaping the Ping, transmitting the shaped Ping to the communication terminal, receiving a response from the communication terminal, making band data indicative of an actually usable band, based on the response and the Ping data, and varying the shaping rate in accordance with the band data.

It is preferable that the steps further include determining an interval at which the band is to be measured, and varying the shaping rate at the interval.

There is further provided a program for causing a computer to carry out a method of determining a shaping rate at which communication is made with a communication terminal through a best-effort type network, steps executed by the computer in accordance with the program including transmitting at least one control packet used for measuring a band, shaping the control packet, transmitting the shaped control packet to the communication terminal, receiving band data indicative of an actually usable band, from the communication terminal, making band data indicative of an actually usable band, based on the band data, and varying the shaping rate in accordance with the band data.

It is preferable that the steps further include determining an interval at which the band is to be measured, and varying the shaping rate at the interval.

In yet another aspect of the present invention, there is provided a system for determining a shaping rate, comprising an apparatus for determining a shaping rate, at least one communication terminal, and a best-effort type network through which the apparatus and the communication terminal make communication with each other, wherein the apparatus includes a Ping transmitter transmitting at least one Ping used for measuring a band, and Ping data indicative of the Ping, a first controller receiving the Ping from the Ping transmitter and transmitting the Ping in accordance with a priority thereof, a judgment unit receiving the Ping data from the Ping transmitter, and a second controller determining a shaping rate and shaping the Ping received from the first controller, wherein the judgment unit makes band data indicative of an actually usable band, based on a response received from the communication terminal and the Ping data received from the Ping transmitter, and transmits the band data to the second controller, and the second controller varies a shaping rate in accordance with the band data received from the judgment unit.

There is further provided a system for determining a shaping rate, comprising an apparatus for determining a shaping rate, at least one communication terminal, and a best-effort type network through which the apparatus and the communication terminal make communication with each other, wherein the apparatus includes a packet transmitter transmitting at least one control packet used for measuring a band, a first controller receiving the control packet from the packet transmitter and transmitting the control packet in accordance with a priority thereof, and a second controller determining a shaping rate and shaping the control packet received from the first controller, wherein the second controller receives band data indicative of an actually usable band, from the communication terminal, and varies a shaping rate in accordance with the band data.

The advantages obtained by the aforementioned present invention will be described hereinbelow.

Though a usable band varies in accordance with a place, a time and/or a provider in a best-effort type network in which a band is not guaranteed, the apparatus, system, method and program in accordance with the present invention make it possible to periodically measure a band of a usable channel, and automatically change a band of network devices, ensuring enhancement in quality of communication.

The above and other objects and advantageous features of the present invention will be made apparent from the following description made with reference to the accompanying drawings, in which like reference characters designate the same or similar parts throughout the drawings.

### BRIEF DESCRIPTION OF THE DRAWINGS

FIG. 1 illustrates a network system including a best-effort type network.

FIG. 2A is a block diagram of an apparatus for determining a shaping rate, in accordance with the first embodiment of the present invention.

FIG. 2B is a block diagram of the first controller in the apparatus in accordance with the first embodiment.

FIG. 3 illustrates an example of a network system in which the apparatus in the apparatus in accordance with the first embodiment is used.

FIG. 4 illustrates communication made after a shaping rate has been varied in the first embodiment.

FIG. 5 illustrates an example of a network system in which the apparatus in the apparatus in accordance with the second embodiment is used.

FIG. 6 illustrates an example of a network system in which the apparatus in the apparatus in accordance with the third embodiment is used.

FIG. 7 is a block diagram of an apparatus for determining a shaping rate, in accordance with the third embodiment of the present invention.

FIG. 8 is a block diagram of a communication terminal in the third embodiment of the present invention.

### DESCRIPTION OF THE PREFERRED EMBODIMENTS

Preferred embodiments in accordance with the present invention will be explained hereinbelow with reference to drawings.

### First Embodiment

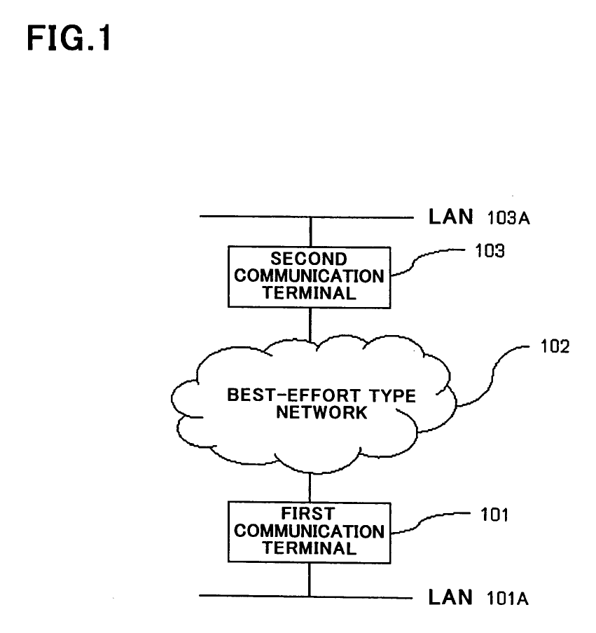

FIG. 1 illustrates a network system including a best-effort type network.

As illustrated in FIG. 1, a first communication terminal 101 is designed to make communication with a second communication terminal 103 through a best-effort type network 102. The first communication terminal 101 is connected to a first LAN 101A, and the second communication terminal 103 is connected to a second LAN 103A.

The first communication terminal 101 includes an apparatus 105 for determining a shaping rate, in accordance with the first embodiment of the present invention.

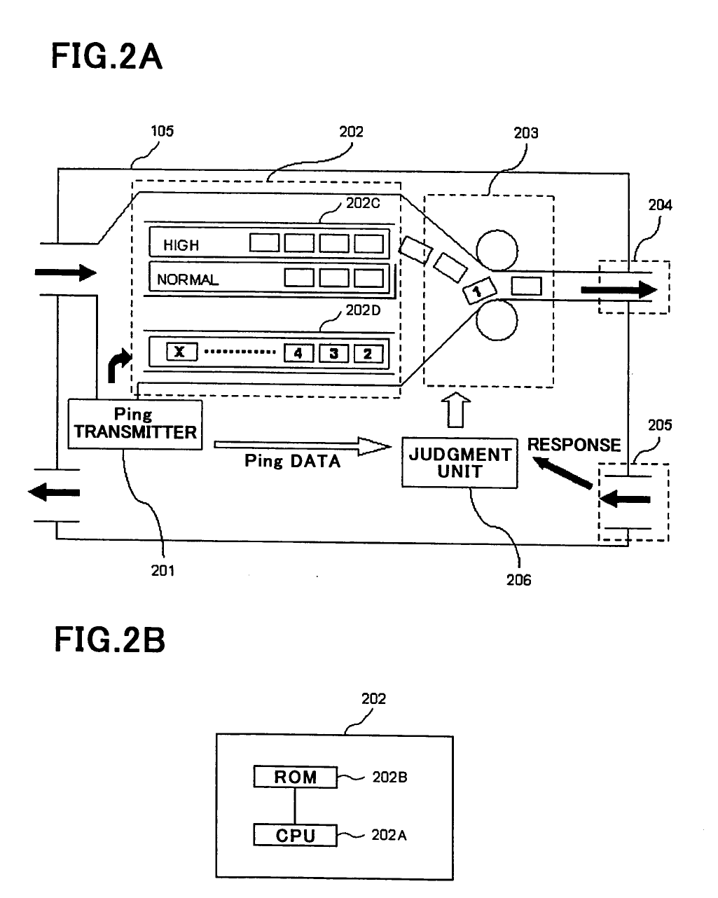

FIG. 2A is a block diagram of the apparatus 105 for determining a shaping rate. The apparatus 105 controls a band (a shaping rate) of an output interface of the first communication terminal 101 through the use of Ping (packet internet groper) in accordance with a band of the best-effort type network 102 in which a band is not guaranteed. The apparatus 105 may use a control packet in place of Ping to control a band of an output interface of the first communication terminal 101.

As illustrated in FIG. 2A, the apparatus 105 is comprised of a Ping transmitter 201 which transmits Ping packets used for measuring a band, and Ping data indicative of the Ping packets, a first controller 202 which receives Ping packets from the Ping transmitter 201 and transmits the received Ping packets in accordance with a priority thereof, a second controller 203 which determines a shaping rate and shapes the Ping packets received from the first controller 202, in accordance with the determined shaping rate, a packet transmitter 204 through which the Ping packets are transmitted to the second communication terminal 103 from the second controller 203, a packet receiver 205 which receives a response packet from the second communication terminal 103 and transmits the received response packet to a later mentioned judgment unit 206, and a judgment unit 206 which receives the Ping data from the Ping transmitter 201, and the response packet from the packet receiver 205.

The Ping transmitter 201 transmits Ping packets to the first controller 202, and further transmits Ping data indicative of the Ping packets transmitted to the first controller 202, to the judgment device 206. A number the Ping packets to be transmitted to the first controller 202, and a packet size of a Ping are determined in advance. In place of a Ping, there may be used a control packet for measuring a band.

FIG. 2B is a block diagram of the first controller 202.

As illustrated in FIG. 2B, the first controller 202 is comprised of a central processing unit 202A and a memory 202B.

The memory 202B is comprised of a semiconductor memory such as a read only memory (ROM), a random access memory (RAM) or an IC memory card, or a storage device such as a flexible disc, a hard disc or an optic magnetic disc. In the first embodiment, the memory 202B is comprised of a read only memory (ROM).

The memory 202B stores therein a control program for driving the central processing unit 202A. The central processing unit 202A reads the program out of the memory 202B, and executes the program. Thus, the central processing unit 202A operates in accordance with the program stored in the memory 202B.

The first controller 202 carries out class base queuing (CBQ) control as priority control. Specifically, the first controller 202 assigns a minimum-guaranteed band to each of classes in accordance with a priority of each of the packets. As illustrated in FIG. 2A, the first controller 202 defines a first class 202C through which data packets pass, and a second class 202D through which Ping packets pass. The first controller 202 receives data packets having a high or normal priority, and further receives Ping packets 1 to X from the Ping transmitter 201. The first controller 202 transmits the received data packets to the second controller 203 through the first class 202C, and transmits the received Ping packets 1 to X to the second controller 203 through the second class 202D. The Ping packets are transmitted to the second controller 203 in preference to the data packets. The data packets having a high priority are transmitted to the second controller 203 in preference to the data packets having a normal priority.

Though not illustrated, the second controller 203 is comprised of a central processing unit and a memory, similarly to the first controller 202.

The memory is comprised of a read only memory (ROM), and stores therein a control program for driving the central processing unit. The central processing unit reads the program out of the memory, and executes the program. Thus, the central processing unit operates in accordance with the program stored in the memory.

In the first embodiment, the first and second controllers 202 and 203 are designed to include separate central processing units, however, the first and second controllers 202 and 203 may be designed to include a common central processing unit.

The second controller 203 determines a certain shaping rate. The second controller 203 narrows a band in accordance with the shaping rate, and transmits the packets to the packet transmitter 204.

The packets including Ping packets are transmitted to the second communication terminal 103 through an output interface of the first communication terminal 101.

On receipt of the packets from the first communication terminal 101, the second communication terminal 103 transmits a response packet to the first communication terminal 101 in response to the Ping packets.

The apparatus 105 in the first communication terminal 101 receives the response packet from the second communication terminal 103 through the packet receiver 205. The received response packet is transmitted to the judgment unit 206.

On receipt of the response packet from the second communication terminal 103 and the Ping data from the Ping transmitter 201, the judgment unit 206 makes band data indicative of an actually usable band, based on the response packet and the Ping data. Then, the judgment unit 206 transmits the band data to the second controller 203.

The second controller 203 varies a shaping rate in accordance with the band data received from the judgment unit 206. If the Ping transmitter 201 determines an interval at which a band is measured, a usable band is periodically measured, and thus, a shaping rate is periodically varied by the second controller 203.

As mentioned above, the apparatus 105 in accordance with the first embodiment measures a band of the best-effort type network 102 through the use of Ping packets, and automatically and periodically adjusts a band of an output interface of the first communication terminal 101 in accordance with an actually usable band. Hence, the apparatus provides enhancement in communication quality.

For measuring a band, a control packet may be used in place of a Ping packet.

Hereinbelow is explained a process of automatically varying a shaping rate in the apparatus 105 in communication made through a best-effort type network.

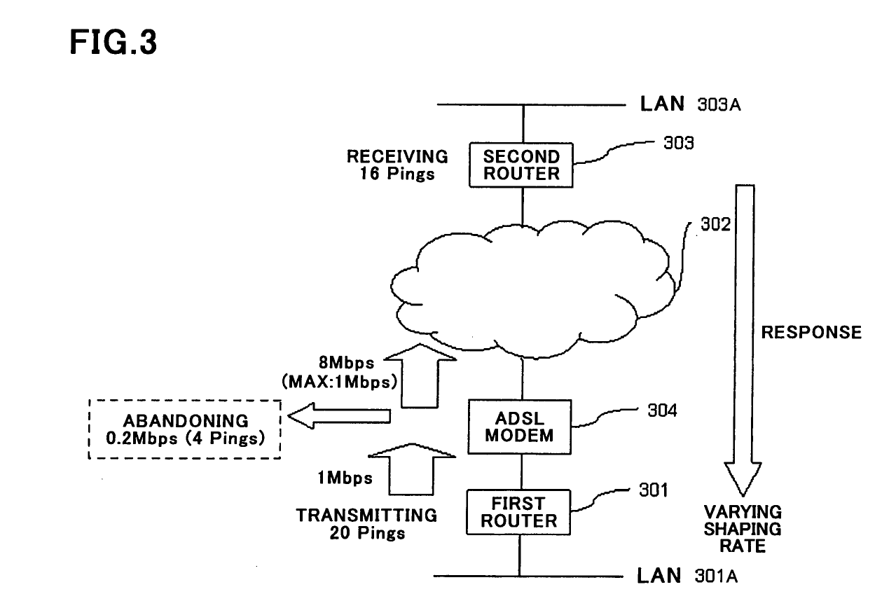

FIG. 3 illustrates an example of a network system in which the apparatus 105 in the apparatus in accordance with the first embodiment is used.

As illustrated in FIG. 3, a first router 301 makes communication with a second router 303 through an ADSL modem 304 and Internet 302. The first router 301 is connected to a first network (not illustrated) through a first LAN 301A, and the second router 303 is connected to a second network (not illustrated) through a second LAN 303A. The first and second networks make communication with each other.

A band of an output interface of the first router 301 is automatically controlled as follows.

The first router 301 is designed to include the apparatus 105 illustrated in FIG. 2A.

On receipt of a Ping packet from the first router 301, the second router 303 transmits a response packet to the first router 301 through Internet 302 and the ADSL modem 304.

It is assumed hereinbelow that a best-effort type network defined between the ADSL modem 304 and Internet 302 ensures a band of 1 Mbps at greatest in an up-channel, but an actually usable band is just 0.8 Mbps.

The Ping transmitter 201 transmits a predetermined number of Ping packets to the first controller 202. Each of the Ping packets has a predetermined packet size. The Ping transmitter 201 further transmits data about the Ping packets transmitted to the first controller 202, to the judgment unit 206.

The first controller 202 carries out priority control or class base queuing (CBQ) control to the received packets. Specifically, the first controller 202 assigns a minimum-guaranteed band to each of classes in accordance with a priority of each of the classes. As illustrated in FIG. 2A, the first controller 202 transmits the received data packets to the second controller 203 through the first class 202C, and transmits the received Ping packets 1 to X to the second controller 203 through the second class 202D. The Ping packets are transmitted to the second controller 203 in preference to the data packets. The data packets having a high priority are transmitted to the second controller 203 in preference to the data packets having a normal priority.

In order to exert less influence on other communication, a minimum-guaranteed band assigned to the second class 202D through which the Ping packets pass is set lower than a minimum-guaranteed band assigned to the first class 202C through which the data packets pass.

The second controller 203 determines a maximum band (shaping rate) among bands at which packets are transmitted to the second router 303 through an output interface of the first router 301. Since the maximum band of 1 Mbps is ensured in an up-channel, the second controller 203 determines a shaping rate to be equal to 1 Mbps.

The first controller 202 carries out the above-mentioned priority control to the data packets receiving for other communication and the Ping packets. The Ping packets are transmitted to the second controller 203 from the first controller 202, and then, shaped in accordance with a shaping rate determined in advance. Then, the Ping packets are transmitted to the packet transmitter 204. Then, the Ping packets as well as the other data packets are transmitted to the second router 303 through an output interface of the first router 301.

The packets including the Ping packets are transmitted to the second router 303 through the ADSL modem 304 and Internet 302. Since a channel between the ADSL modem 304 and Internet 302 is a part of a best-effort type network in which a band is not guaranteed, the ADSL modem 304 may transmit packets at a band equal to or smaller than the shaping rate of 1 Mbps having been determined by the second controller 203 in the first router 301.

In FIG. 3, it is assumed that an actually usable band is 0.8 Mbps. Accordingly, a part of the packets is abandoned in the ADSL modem 304 regardless of a priority of the packets or whether a packet is a Ping packet or not. Specifically, the packets equivalent to 0.2 Mbps (1−0.8=0.2) are abandoned.

On receipt of the packets, the second router 303 transmits a response packet indicating of receipt of the Ping packet, to the first router 301.

FIG. 3 illustrates a case in which the first router 301 transmits twenty (20) Ping packets to the second router 303, four (4) Ping packets are abandoned in the ADSL modem 304, sixteen (16) Ping packets reach the second router 303, and the second router 303 transmits a response packet indicating that the second router 303 has received sixteen Ping packets, to the first router 301.

The response packet is transmitted to the judgment unit 206 through the packet receiver 205 in the first router 301.

On receipt of the response packet transmitted from the second communication terminal 103 and the Ping data transmitted from the Ping transmitter 201, the judgment unit 206 makes band data indicative of an actually usable band, based on the response packet and the Ping data. Then, the judgment unit 206 transmits the band data to the second controller 203.

Then, the second controller 203 varies a shaping rate in accordance with the band data received from the judgment unit 206.

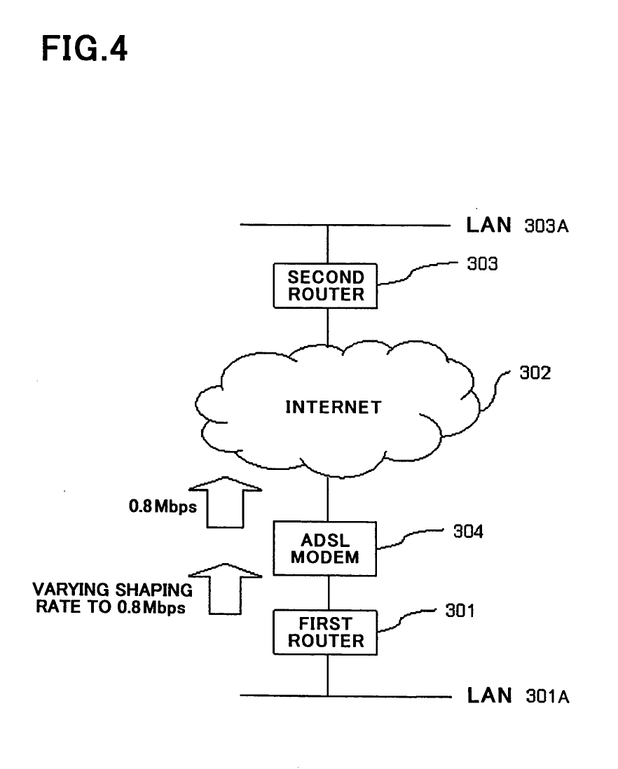

FIG. 4 illustrates communication between the first and second routers 301 and 303 made after a shaping rate of an output interface in the first router 301 has been varied.

The packets transmitted from the first router 301 reach the second router 303 without being abandoned in the best-effort type network in which a band is not guaranteed. The first router 301 periodically measures a band, and automatically optimizes a shaping rate.

A usable band varies in accordance with a place, a time and/or a provider in the best-effort type network 102 in which a band is not guaranteed. The apparatus 105 in accordance with the first embodiment periodically measures a usable band of the best-effort type network 102 through the use of Ping packets, and automatically and periodically adjusts a band of an output interface of the first communication terminal 101 in accordance with the measured usable band. Hence, the apparatus 105 provides enhancement in communication quality.

### Second Embodiment

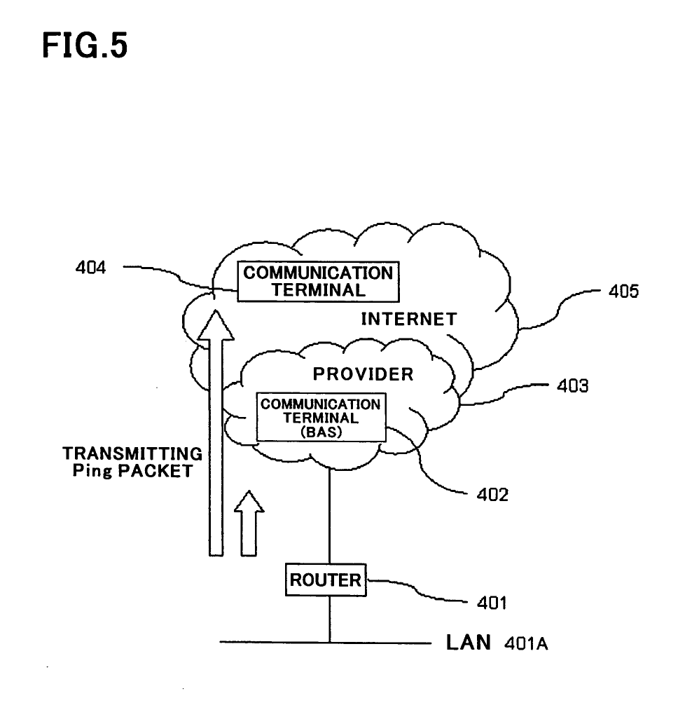

FIG. 5 illustrates an example of a network system in which the apparatus in accordance with the second embodiment is used.

As illustrated in FIG. 5, a router 401 makes communication with Internet 405 through a communication terminal 402 such as BAS of a provider 403. The router 401 makes communication with a network (not illustrated) through LAN 401A.

The router 401 includes the apparatus 105 illustrated in FIG. 2A. Accordingly, a process of automatically controlling a band of an output interface of the router 401 is identical with the process having been explained in the first embodiment.

The network (not illustrated) to which the router 401 is connected through LAN 401A and Internet 405 makes communication with each other through the communication terminal 402. Any terminal can make access to a communication terminal 404 disposed in Internet 405.

On receipt of packets including Ping packets from the router 401, the communication terminals 402 and 404 transmits a response indicating that they have received a Ping packet, to the router 401.

Hereinbelow is explained an operation of the second embodiment.

In FIG. 5, the router 401 and Internet 405 make communication with each other through a best-effort type network in which a band is not guaranteed. A process of automatically controlling a band of an output interface of the router 401 is identical with the process having been explained in the first embodiment.

By directing a Ping packet transmitted from the router 401 to the communication terminal 402 disposed in the provider 403 or the communication terminal 404 disposed in Internet 405, it would be possible to automatically vary a band of an output interface of the router 401, even if the router 401 makes communication with Internet 405.

In the second embodiment, Internet 405 is a best-effort type network in which a band is not guaranteed, and packets not to be abandoned may be abandoned in a channel between the router 401 and the provider 403 or in a channel between the provider 403 and Internet 405. The apparatus in accordance with the second embodiment periodically measures a usable band in a channel between the router 401 and the communication terminal 402 or 404, and automatically varies a band of an output interface of the router 401, ensuring enhancement in communication quality.

### Third Embodiment

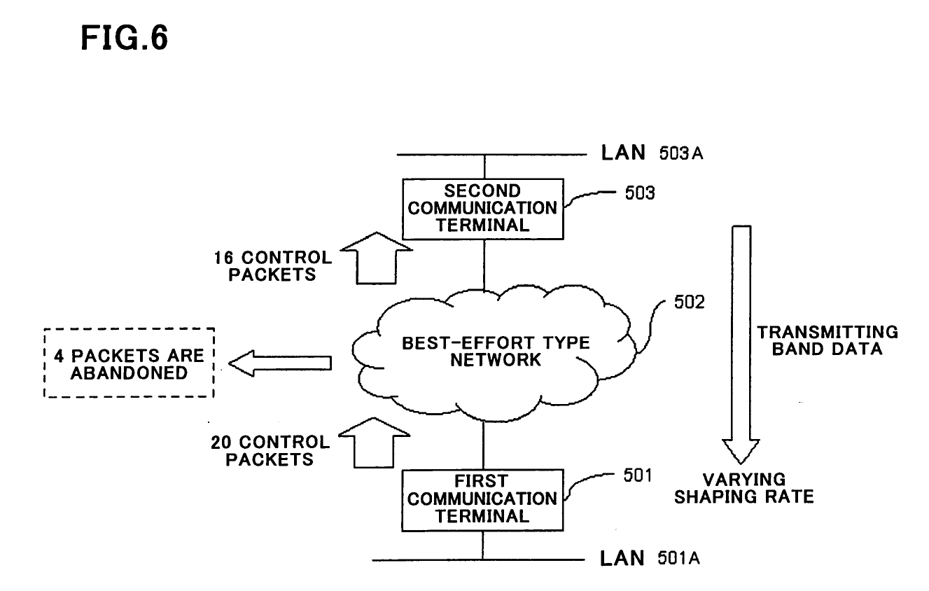

FIG. 6 illustrates an example of a network system in which the apparatus in accordance with the third embodiment is used.

As illustrated in FIG. 6, a first communication terminal 501 is designed to make communication with a second communication terminal 503 through a best-effort type network 502 in which a band is not guaranteed. The first communication terminal 501 is connected to a first LAN 501A, and the second communication terminal 503 is connected to a second LAN 503A.

The first communication terminal 501 includes an apparatus 700 for determining a shaping rate, in accordance with the third embodiment. The apparatus 700 measures a band through the use of a control packet in place of a Ping packet.

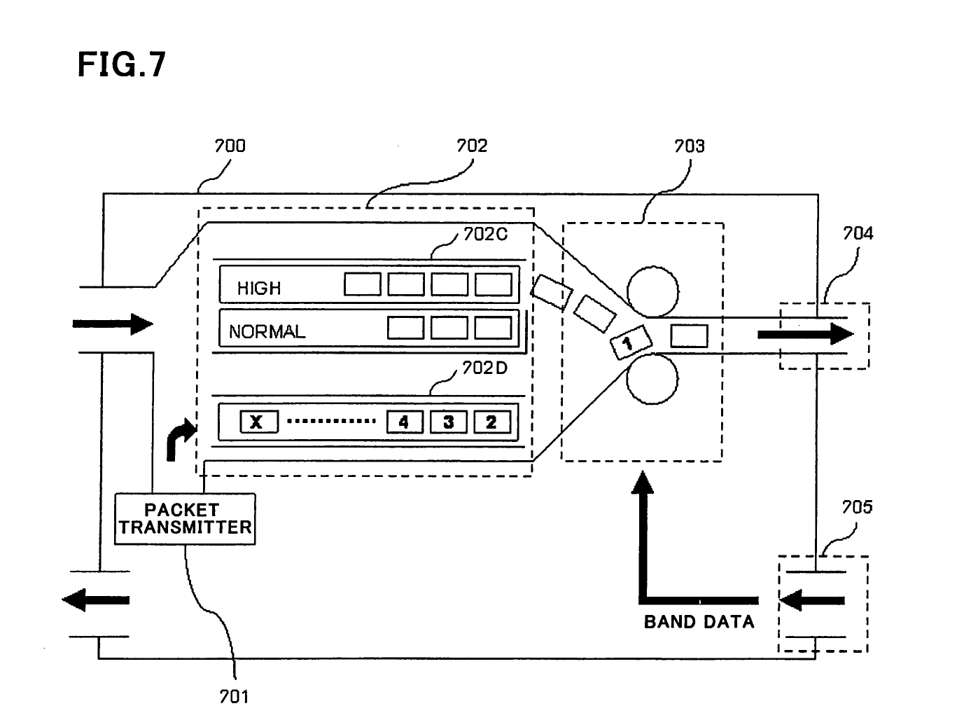

FIG. 7 is a block diagram of the apparatus 700 for determining a shaping rate.

As illustrated in FIG. 7, the apparatus 700 is comprised of a packet transmitter 701 which transmits control packets used for measuring a band, a first controller 702 which receives control packets from the packet transmitter 701 and transmits the received control packets in accordance with a priority thereof, a second controller 703 which determines a shaping rate and shapes the control packets received from the first controller 702, in accordance with the determined shaping rate, a packet transmitter 704 through which the control packets are transmitted to the second communication terminal 503 from the second controller 703, a packet receiver 705 which receives a response packet from the second communication terminal 503 and transmits the received response packet to the second controller 703.

The packet transmitter 701, the first controller 702, the second controller 703, the packet transmitter 704, and the packet receiver 705 correspond to the packet transmitter 201, the first controller 202, the second controller 203, the packet transmitter 204, and the packet receiver 205 in the apparatus 105 in accordance with the first embodiment, illustrated in FIG. 2A.

In comparison with the apparatus 105 illustrated in FIG. 2A, the apparatus 700 illustrated in FIG. 7 does not include a unit corresponding to the judgment unit 206.

An operation of the apparatus 700 is explained hereinbelow.

The packet transmitter 701 transmits control packets to the first controller 702. The control packets transmitted to the first controller 702 includes data indicative of a number and a size of control packets to be transmitted to the first controller 702. In the third embodiment, the control packet is comprised of a UDP packet to which a re-transmission control is not necessary to carry out.

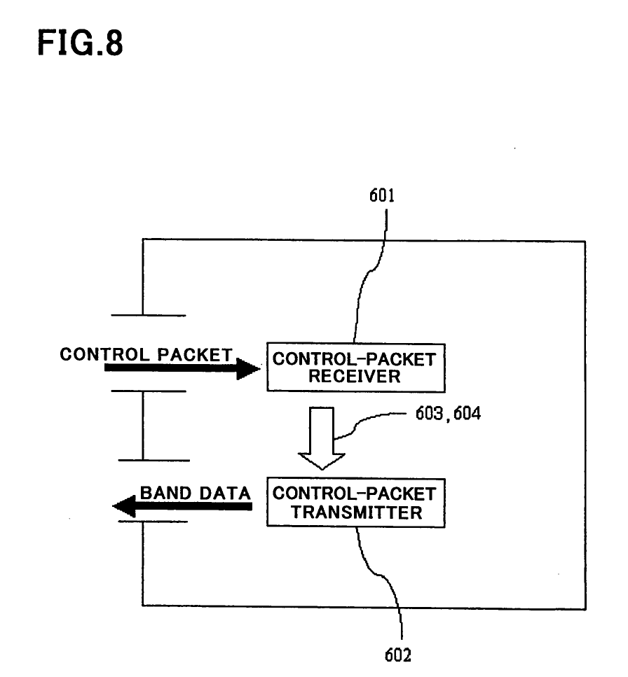

FIG. 8 is a block diagram of the second communication terminal 503.

The second communication terminal 503 is comprised of a control-packet receiver 601 and a band-data transmitter 602. The second communication terminal 503 receives a control packet from the first communication terminal 501 through the control-packet receiver 601. The control-packet receiver 601 takes data 603 indicative of a number of the received control packets and other various data 604, out of the received control packets, and transmits the data 603 and 604 to the band-data transmitter 602.

On receipt of the data 603 and 604 from the control-packet receiver 601, the band-data transmitter 602 calculates a band, based on the data 603 and 604.

Then, the band-data transmitter 602 transmits data indicative of the calculated band, to the first communication terminal 501.

The first communication terminal 501 receives the band data from the second communication terminal 503 through the packet receiver 705, and then, transmits the received band data to the second controller 703.

On receipt of the band data from the packet receiver 705, the second controller 703 varies a shaping rate in accordance with the received band data.

A usable band varies in accordance with a place, a time and/or a provider in the best-effort type network 502 in which a band is not guaranteed. The apparatus 700 in accordance with the third embodiment periodically measures a usable band in the best-effort type network 502 through the use of control packets, and automatically and periodically adjusts a band of an output interface of the first communication terminal 501 in accordance with the measured usable band. Hence, the apparatus 700 provides enhancement in communication quality.

In addition, since a band is measured through the use of a control packet, the second communication terminal 503 is required to transmit only one control packet as a response to the first communication terminal 501. This ensures reduction in a burden in the second communication terminal 503 and the network 502 through which a control packet as a response passes.

While the present invention has been described in connection with certain preferred embodiments, it is to be understood that the subject matter encompassed by way of the present invention is not to be limited to those specific embodiments. On the contrary, it is intended for the subject matter of the invention to include all alternatives, modifications and equivalents as can be included within the spirit and scope of the following claims.

The entire disclosure of Japanese Patent Application No. 2003-134768 filed on May 13, 2003 including specification, claims, drawings and summary is incorporated herein by reference in its entirety.

What is claimed is:

1. An apparatus for determining a shaping rate, to make communication with a communication terminal through a best-effort type network, comprising:
a Ping transmitter transmitting at least one Ping used for measuring a band, and Ping data indicative of said Ping;
a first controller receiving said Ping from said Ping transmitter and transmitting said Ping in accordance with a priority thereof;
a judgment unit receiving said Ping data from said Ping transmitter; and
a second controller determining a shaping rate and shaping said Ping received from said first controller;
wherein said judgment unit makes band data indicative of an actually usable band, based on a response received from said communication terminal and said Ping data received from said Ping transmitter, and transmits said band data to said second controller, and
said second controller varies a shaping rate in accordance with said band data received from said judgment unit.

2. The apparatus as set forth in claim 1, further comprising a packet transmitter through which said Ping is transmitted to said communication terminal from said second controller.

3. The apparatus as set forth in claim 1, further comprising a packet receiver which receives said response from said communication terminal and transmits the received response to said judgment unit.

4. The apparatus as set forth in claim 1, wherein said Ping transmitter determines a number of Ping packets to be transmitted therefrom, and a packet size.

5. The apparatus as set forth in claim 1, wherein said Ping transmitter transmits a control packet in place of said Ping.

6. The apparatus as set forth in claim 1, wherein said Ping measures a band of a communication terminal disposed in a provider.

7. The apparatus as set forth in claim 1, wherein said first controller assigns a minimum-guaranteed band to each of classes.

8. The apparatus as set forth in claim 1, wherein said first controller inserts said Ping received from said Ping transmitter and other packets into separate classes.

9. The apparatus as set forth in claim 8, wherein said first controller assigns a minimum-guaranteed band to a class through which said Ping passes which band is lower than a minimum-guaranteed band to be assigned to a class through which said packets passes.

10. The apparatus as set forth in claim 1, wherein said second controller determines a maximum shaping rate among shaping rates at which said Ping is transmitted from said second controller.

11. The apparatus as set forth in claim 1, wherein said Ping transmitter determines an interval at which said actually usable band is measured.

12. An apparatus for determining a shaping rate, to make communication with a communication terminal through a best-effort type network, comprising:
a packet transmitter transmitting at least one control packet used for measuring a band;
a first controller receiving said control packet from said packet transmitter and transmitting said control packet in accordance with a priority thereof and
a second controller determining a shaping rate and shaping said control packet received from said first controller,
wherein said second controller receives band data indicative of an actually usable band, from said communication terminal, and varies a shaping rate in accordance with said band data.

13. The apparatus as set forth in claim 12, wherein said packet transmitter determines a number of control packets to be transmitted therefrom, and a packet size.

14. The apparatus as set forth in claim 12, wherein said second controller determines a maximum shaping rate among shaping rates at which said control packet is transmitted from said second controller.

15. The apparatus as set forth in claim 12, wherein said packet transmitter determines an interval at which said actually usable band is measured.

16. A method of determining a shaping rate at which communication is made with a communication terminal through a best-effort type network, comprising:
transmitting at least one Ping used for measuring a band, and Ping data indicative of said Ping;
shaping said Ping;
transmitting the shaped Ping to said communication terminal;
receiving a response from said communication terminal;
making band data indicative of an actually usable band, based on said response and said Ping data; and
varying said shaping rate in accordance with said band data.

17. The method as set forth in claim 16, further comprising:
determining an interval at which said band is to be measured; and
varying said shaping rate at said interval.

18. A method of determining a shaping rate at which communication is made with a communication terminal through a best-effort type network, comprising:
transmitting at least one control packet used for measuring a band;
shaping said control packet;
transmitting the shaped control packet to said communication terminal;
receiving band data indicative of an actually usable band, from said communication terminal;
making band data indicative of an actually usable band, based on said band data; and
varying said shaping rate in accordance with said band data.

19. The method as set forth in claim 18, further comprising:
determining an interval at which said band is to be measured; and
varying said shaping rate at said interval.

20. A program for causing a computer to carry out a method of determining a shaping rate at which communication is made with a communication terminal through a best-effort type network, steps executed by said computer in accordance with said program including:
transmitting at least one Ping used for measuring a band, and Ping data indicative of said Ping;
shaping said Ping;
transmitting the shaped Ping to said communication terminal;
receiving a response from said communication terminal;
making band data indicative of an actually usable band, based on said response and said Ping data; and
varying said shaping rate in accordance with said band data.

21. The program as set forth in claim 20, wherein said steps further include:
determining an interval at which said band is to be measured; and
varying said shaping rate at said interval.

22. A program for causing a computer to carry out a method of determining a shaping rate at which communication is made with a communication terminal through a best-effort type network, steps executed by said computer in accordance with said program including:
transmitting at least one control packet used for measuring a band;
shaping said control packet;
transmitting the shaped control packet to said communication terminal;
receiving band data indicative of an actually usable band, from said communication terminal;
making band data indicative of an actually usable band, based on said band data; and
varying said shaping rate in accordance with said band data.

23. The program as set forth in claim 22, wherein said steps further include:
determining an interval at which said band is to be measured; and
varying said shaping rate at said interval.

24. A system for determining a shaping rate, comprising an apparatus for determining a shaping rate, at least one communication terminal, and a best-effort type network through which said apparatus and said communication terminal make communication with each other,
wherein said apparatus includes:
a Ping transmitter transmitting at least one Ping used for measuring a band, and Ping data indicative of said Ping;
a first controller receiving said Ping from said Ping transmitter and transmitting said Ping in accordance with a priority thereof;
a judgment unit receiving said Ping data from said Ping transmitter; and
a second controller determining a shaping rate and shaping said Ping received from said first controller;
wherein said judgment unit makes band data indicative of an actually usable band, based on a response received from said communication terminal and said Ping data received from said Ping transmitter, and transmits said band data to said second controller, and
said second controller varies a shaping rate in accordance with said band data received from said judgment unit.

25. A system for determining a shaping rate, comprising an apparatus for determining a shaping rate, at least one communication terminal, and a best-effort type network through which said apparatus and said communication terminal make communication with each other,
wherein said apparatus includes:
a packet transmitter transmitting at least one control packet used for measuring a band;
a first controller receiving said control packet from said packet transmitter and transmitting said control packet in accordance with a priority thereof; and
a second controller determining a shaping rate and shaping said control packet received from said first controller,
wherein said second controller receives band data indicative of an actually usable band, from said communication terminal, and varies a shaping rate in accordance with said band data.
